(19) United States
(12) Patent Application Publication
(10) Pub. No.: US 2014/0316690 A1
(43) Pub. Date: Oct. 23, 2014

(54) Device and method for determining the position of a vehicle

(71) Applicants: Stefan Nordbruch, Kornwestheim (DE); Thomas Kropf, Reutlingen (DE); Christian Braeuchle, Hassmersheim Hochausen (DE)

(72) Inventors: Stefan Nordbruch, Kornwestheim (DE); Thomas Kropf, Reutlingen (DE); Christian Braeuchle, Hassmersheim Hochausen (DE)

(21) Appl. No.: 14/343,187

(22) PCT Filed: Jul. 17, 2012
(86) PCT No.: PCT/EP2012/063957

§ 371 Date: Jun. 13, 2014

(30) Foreign Application Priority Data
Sep. 13, 2011 (DE) 10 2011 082 571.1

(51) Int. Cl. G01C 21/26

(52) U.S. Cl. CPC G01C 21/26
USPC 701/408

(57) ABSTRACT

A device for determining a position of a vehicle, including a position determining device for determining the position, and a transmitter for sending the position to the vehicle. Also described is a method and a system for determining a position of a vehicle. In addition, a computer program is also described.

### FIELD OF THE INVENTION

The present invention relates to a device and a method for determining the position of a vehicle. The present invention further relates to a vehicle, a system for determining a position of a vehicle and a computer program.

BACKGROUND INFORMATION

The use of navigation systems in a vehicle for determining the vehicle position is discussed, for example, in laid-open document WO 2004/102986 A2.

While using navigation systems which, as a rule, include Global Positioning Systems (GPS) sensors, it may happen that the reception of satellites required for the use of the GPS sensors is not sufficient for determining a position of the vehicle.

Furthermore, not every vehicle is equipped with a navigation system, since this is technically effortful to install in the vehicle.

### SUMMARY OF THE INVENTION

An object on which the present invention is based may therefore be seen in stating a device for determining a position of a vehicle, which makes it possible to determine the vehicle position even if the vehicle itself has no navigation system and/or the reception of satellites is experiencing interference.

The object on which the present invention is based may also be seen in determining a corresponding method for determining the position of a vehicle.

The object on which the present invention is based may also be seen as stating a corresponding vehicle, a corresponding system for determining a position of a vehicle and a corresponding computer program.

According to one aspect, a device for determining a position of a vehicle is provided. The device includes a position determining device by which the position of the vehicle is able to be determined. Furthermore, a transmitter is provided, which is able to transmit the position, that was determined by the position determining device, to the vehicle.

According to another aspect, a method for determining a position of a vehicle is provided. In this instance, the position of the vehicle is determined and transmitted to the vehicle.

According to another aspect, a vehicle is provided which includes a device for determining a position of a vehicle.

According to still another aspect, a system is provided for determining a position of a vehicle, the system including an external server and a device for determining a position of a vehicle; the transmitter being further developed to transmit the position of the vehicle to the external server.

According to yet another aspect, a computer program is provided, which includes program code to execute the method for determining the position of a vehicle when the computer program is run on a computer.

Thus, the present invention includes particularly the idea of determining the vehicle position using an external position determining device and, subsequently, to send this determined vehicle position to the vehicle itself. The formulation “external”, within the meaning of the present invention, particularly characterizes a region outside the vehicle whose position is to be determined. Thus, this means that an external position determining device is situated externally to the vehicle and not in or on the vehicle, whose position is to be determined.

That is, because the vehicle position is determined externally to the vehicle and sent to the vehicle, the vehicle itself does not need to have a navigation system for determining its vehicle position. One may thereby do without a technical installation cost of a navigation system in the vehicle. Moreover, it is also not important whether the vehicle, whose position is to be determined, has sufficient satellite reception for the use of a GPS sensor, since the vehicle position is determined by an external arrangement, in this instance particularly by using the position determining device. Thus, for example, the vehicle may be in a tunnel, and nevertheless receive its position.

In addition, the vehicle, whose position was determined externally, is able advantageously to use this externally determined vehicle position to improve the accuracy of a vehicle position which, for example, the vehicle had determined for itself using a navigation system, i.e. the internally determined vehicle position determining device. Thus, for example, the accuracy of a GPS sensor of a navigation system may be sufficient to place the vehicle on a certain road, using the internal position determination, but may not be able to tell accurately in which lane the vehicle is located. Using the externally determined vehicle position, in a particularly advantageous manner, the accuracy of the internally determined vehicle position may then be improved to the extent that the vehicle gains the knowledge as to which lane it is in.

According to one specific embodiment, the device for determining the position of a vehicle is situated in an additional vehicle. This means, in particular, that the additional vehicle ascertains or determines the position of the vehicle using the position determining device, and then sends this position to the vehicle. For the reception of the transmitted position it may particularly be provided that the vehicle has a correspondingly developed receiver.

According to another specific embodiment, the position determining device is further developed to determine an instantaneous position determining device of the position determining device. Furthermore, a sensor system is formed for recording a kinematic state variable of the vehicle. Thus, on the one hand, the instantaneous position of the position determining device is determined. On the other hand, a kinematic state variable of the vehicle, whose position is to be determined, is recorded by a sensor. By kinematic state variable, within the meaning of the present invention, one should understand particularly a physical variable which is able to describe a motion of the vehicle. In particular, a kinematic state variable is able to include a speed and/or an acceleration of the vehicle. In the case of the abovementioned variables, a vector variable may be involved, so that the direction in which the vehicle is traveling or accelerating is also taken into account. In particular, a kinematic state variable may also be a distance between the position determining device and the vehicle itself. In the case of the speed and/or the acceleration of the vehicle, we may be talking about an absolute and/or a relative variable. Relative, in this case, means especially that the recorded state variable is determined relative to the position determining device. If the device is situated in a vehicle in particular, the kinematic state variable is particularly determined relative to the vehicle. This means then, in particular, that a relative speed and/or a relative acceleration are determined with reference to the vehicle using the position determining device.

Based on the position of the position determining device and the kinematic state variable, a position of the vehicle may then be calculated in an advantageous manner and sent to the vehicle.

In general, particularly the position determining device and the sensor system are associated with a physical object. This particularly means that the physical object includes the position determining device and the sensor system. The physical object may be, for instance, a fixedly situated, i.e. stationary physical object. This then means in particular that the stationary object is situated besides or in the vicinity of a road, and the positions of the vehicles passing along the road are determined and the corresponding positions are subsequently transmitted to the respective vehicle.

The physical object may particularly also be an additional vehicle. This means especially that the additional vehicle determines its own instantaneous vehicle position, records a kinematic state variable of the vehicle whose position is to be determined, based on the kinematic state variable and the vehicle's own instantaneous vehicle position, and subsequently also sends this position to the vehicle, so that the vehicle then advantageously gains knowledge about its own vehicle position.

According to one specific embodiment, it may be provided, in order to determine the instantaneous position determining device of the physical object, that a Global Positioning System (GPS) be used. In particular, a differential GPS system may also be used. In case the physical object is a vehicle, an odometry sensor system may also particularly be provided.

According to one specific embodiment, the sensor system includes one or more radar sensors. In particular, the sensor system may include an ultrasonic sensor or multiple ultrasonic sensors. The sensor system may encompass a video camera, especially a 3D video camera, an environmental camera system for recording images of a 360° environment of a vehicle, a Lidar sensor, a flight time sensor and/or a photo mixing detector, also known in English as photonic mixing device (PMD) sensor. A PMD sensor in particular is able to be employed as image sensor in TOF cameras, TOF being the abbreviation of “time of flight” and based on light-propagation time methods. The video camera may be a stereo video camera, in particular.

According to one further specific embodiment, the sensor system may be developed as an environmental sensor system of a vehicle assistance system. This, then, means in particular that the environmental sensor system of a vehicle assistance system is used to record a kinematic state variable of the vehicle assistance system. An environmental sensor system of a vehicle assistance system within the meaning of the present invention includes particularly the abovementioned sensor types and video camera systems. Thus, it may be provided, for example, that the radar sensors of an adaptive cruise controller are also used to record a kinematic state variable of the vehicle and to determine the position of the vehicle.

According to an additional specific embodiment, it may be provided that the position of the vehicle is transmitted to an external server. This, then, means in particular that the position is sent to a server which is not situated in any vehicle. This external server may advantageously send the position of the vehicle, for example, to other vehicles, so that the other vehicles advantageously gain knowledge on where the vehicle is located. Especially when the respective positions of a multiplicity of vehicles are determined, these vehicles each may gain knowledge on the other positions of the vehicles. This advantageously increases the safety in road traffic.

According to another specific embodiment, it may be provided that the recorded state variable and the instantaneous position be sent to the external server, which determines the position of the vehicle as a function of this. Consequently, a possibly time-consuming and costly calculation of the vehicle position, based on the recorded state variable and the instantaneous position may be outsourced to the external server.

If the instantaneous position is known, and if, in addition, a kinematic state variable of the vehicle, whose position is to be determined, is known, this being particularly about a distance between the vehicle and the position determining device and the physical object, the position of the vehicle is able to be ascertained and calculated. For this purpose, for instance, a triangulation method, especially a triangulation method using a satellite, may be used.

A communication between vehicles or between a vehicle and an external server, may particularly be carried out using a wireless communications method. This may be particularly about a WLAN communications method and/or about Long-Term Evolution (LTE) communications methods.

According to one specific embodiment, a quality factor, also called quality flag in English, is assigned to the determined position, and it may particularly be normalized. Consequently, the vehicle, whose position is being determined, advantageously receives information as to how reliable the determined position is, and the accuracy with which it was ascertained. A quality factor may also particularly include information on a type and/or a quality of a sensor system, for instance, on whether it has qualitatively high-value or low-value components.

In yet another specific embodiment, it may be provided that the vehicle receive its vehicle position determined by the respective vehicle or object from a plurality of additional vehicles and/or physical objects. Now in this case, it may particularly be provided that the vehicle carries out an averaging over the various vehicle positions, so as to determine an average vehicle position for itself. This averaging may also particularly be carried out using an external server, and then may be sent to the vehicle. In this case, for instance, advantageously a corresponding averaging device of the vehicle may then be configured to be weaker with respect to calculating performance.

It may be provided that, for the averaging, the various vehicle positions are weighted using different weighting factors, so that, for instance, vehicle positions, which were determined using a modern sensor system, experience greater weighting than vehicle positions which were ascertained using an older sensor system. The kind and the type of the sensor system may also be taken into account with respect to an appropriate weighting. It may particularly be provided that, for the averaging, the various vehicle positions are weighted with time factors, so that, for instance, determined vehicle positions, younger in time, are taken into account more greatly than vehicle positions older in time.

The present invention will be explained below in greater detail with reference to the exemplary embodiments.

### BRIEF DESCRIPTION OF THE DRAWINGS

FIG. 1 shows a device for determining a position of a vehicle.

FIG. 2 shows two vehicles.

FIG. 3 shows a flow chart of a method for determining a position of a vehicle.

FIG. 4 shows a flow chart of an additional method for determining a position of a vehicle.

FIG. 5 shows a system for determining a position of a vehicle.

FIG. 6 shows a plurality of vehicles on a road.

FIG. 7 shows a plurality of vehicles on a road.

FIG. 8 shows a plurality of vehicles on a road.

### DETAILED DESCRIPTION

In the following text, the same reference numerals are used for the same features.

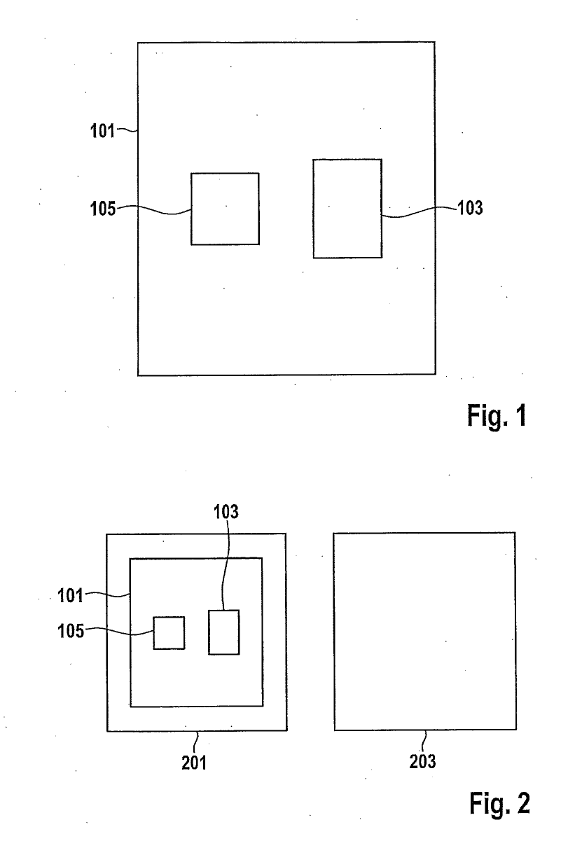

FIG. 1 shows a device 101 for determining the position of a vehicle (not shown). Device 101 includes a position determining device 103 for determining the position of the vehicle. Furthermore, device 101 includes a transmitter 105, which sends the position of the vehicle to the vehicle.

Because the position of the vehicle is determined externally to the vehicle and this is then sent to the vehicle, the vehicle is advantageously informed on its instantaneous position. It is thereby possible for the vehicle itself not to need a navigation system for determining its own position. Moreover, in this way the vehicle is thus able to gain knowledge on its own vehicle position even when a contact of a GPS sensor to a satellite is experiencing interference, such as when the vehicle is located in a tunnel.

FIG. 2 shows two vehicles 201 and 203. Vehicle 201 includes device 101 in FIG. 1. The position of vehicle 203 is determined using position determining device 103. The position thus determined is then sent from vehicle 201 to vehicle 203, using transmitter 105, so that vehicle 203 is informed on its vehicle position. For this it may particularly be provided that vehicle 203 has an appropriately configured receiver (not shown).

In one specific embodiment that is not shown, it may be provided that device 101 is situated in or on a stationary physical object. Such an object may be situated, for example, in a stationary manner on or besides a road, and is able to determine the instantaneous vehicle positions of passing vehicles, and send the determined positions to the respective vehicles.

In one specific embodiment that is not shown, position determining device 103 includes a GPS sensor, particularly a differential GPS sensor. Using this sensor, an instantaneous position of vehicle 201 is then able to be determined by itself, that is, particularly position determining device 103 itself. Furthermore, position determining device 103 particularly includes a sensor system for recording a kinematic state variable of vehicle 203. The state variable is especially a distance between the two vehicles 201 and 203. This then means particularly that the sensor system records a distance between the two vehicles 201 and 203. As a function of the recorded distance and the instantaneous vehicle position of vehicle 201, the instantaneous vehicle position of vehicle 203 may then be calculated. For this, a triangulation method may be used, for example.

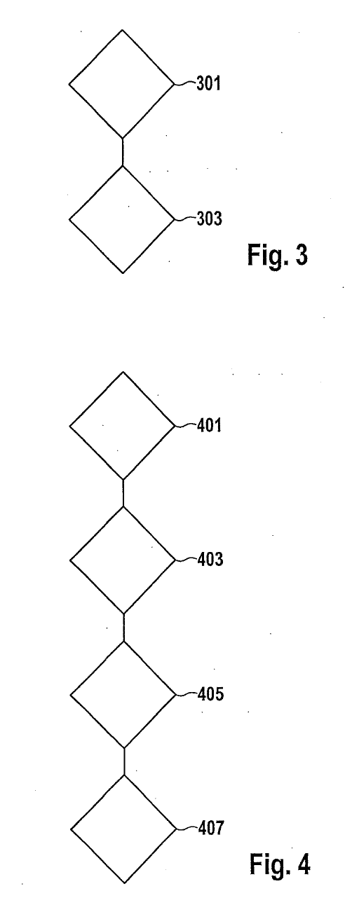

FIG. 3 shows a flow chart of a method for determining a position of a vehicle. In a step 301, the position of the vehicle is determined. In a step 303, the determined position is sent to the vehicle.

FIG. 4 shows a flow chart of an additional method for determining a position of a vehicle. In a step 401, an instantaneous position of a position determining device is determined. In a step 403, the distance between the position determining device and the vehicle is then recorded. In a step 405, as a function of the instantaneous position of the position determining device and the recorded distance, a position of the vehicle is determined, which is then sent to the vehicle in a step 407.

In addition to the distance, it may particularly also be provided that an absolute and/or relative speed and/or acceleration of the vehicle is recorded. Relative, in this instance, means especially that the corresponding variable is a variable of the vehicle with respect to the position determining device. In this case, in particular, if the position determining device is situated in an additional vehicle, a relative speed and/or a relative acceleration is measured between the two vehicles. Furthermore, an angle of the vehicle may also be recorded.

Alternatively or in addition, it may be provided, in a further specific embodiment, that in step 407 the recorded state variables and the instantaneous position are sent to an external server which, as a function of this, calculates the position of the vehicle and sends this to the vehicle. The external server may send the position of the vehicle to additional vehicles. Consequently, in an advantageous manner, a plurality of vehicles on one road is informed on the position of one vehicle. Especially when the positions of a plurality of vehicles are determined, the server is able to send the vehicle position thus determined to the individual vehicles, so that each vehicle is informed on where the other vehicles, which are also located on the road, are exactly located. This information may then be shown to a driver, using a video screen, for example, so that he knows where the vehicles are and how many, even at poor visibility. This information may particularly also be provided to driver assistance systems, which as a function thereof are able to decide whether they are intervening in a braking system, a drive system or a steering system of the vehicle, so as to brake the vehicle, accelerate it and/or steer it, so as prevent potentially dangerous driving situations.

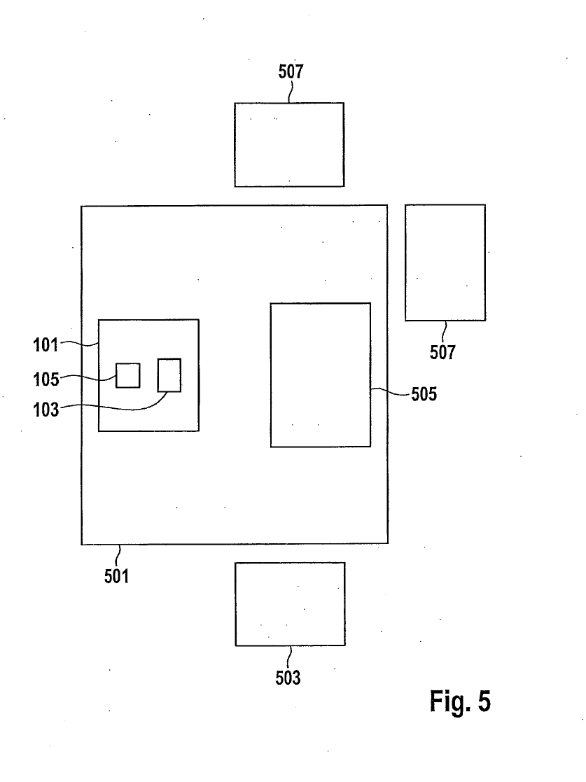

FIG. 5 shows a system 501 for determining the position of a vehicle 503. System 501 includes device 101 and an external server 505. Device 101 records the position of vehicle 503 and sends this to external server 505. External server 505 then sends the position of vehicle 503 to additional vehicles 507. Server 505 may also send the position of vehicle 503 to vehicle 503.

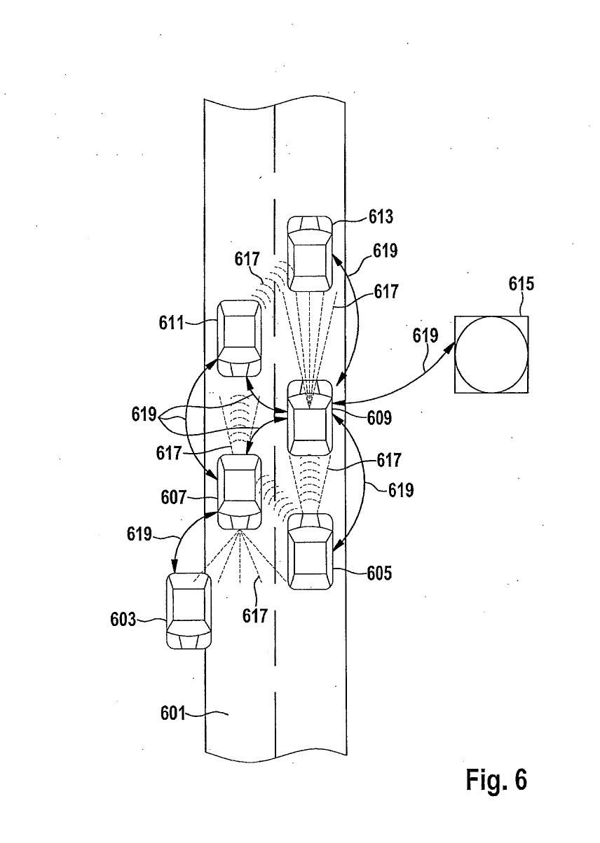

FIG. 6 shows a road 601, on which six vehicles 603, 605, 607, 609, 611 and 613 are located. Vehicle 603 is a stationary vehicle. This means, in particular, that vehicle 603 does not move on road 601, but has stopped. The other five vehicles 603, 605, 607, 609, 611 and 613 are traveling along road 601 in a common direction.

Furthermore, on the right next to road 601, a stationary physical object 615 is situated, whose position is known to vehicles 603, 605, 607, 609, 611 and 613. Object 615 may be drawn in on a digital map of a navigation system, for example.

The five vehicles 603, 605, 607, 609, 611 and 613 each record with their respective sensor systems (not shown) a kinematic state variable of the other vehicles and of vehicle 603 and of object 615. In particular, in this instance, a respective distance is recorded between two vehicles and between a vehicle and object 615. It may also be provided, however, that an absolute and/or a relative speed and/or acceleration of the vehicles be recorded. In particular, it may also be provided that an angle of the individual vehicles with respect to one another be recorded. This sensor recording is shown here using various symbols, which are characterized in the drawing by reference numerals 617.

The individual sensor systems may be, for instance, an ultrasonic sensor, a video sensor, a radar sensor, a PMD sensor or a sensor system directed backwards.

Vehicles 603, 605, 607, 609, 611 and 613 exchange with one another the respectively recorded state variables. Furthermore, these vehicles exchange, if present, their own instantaneous vehicle position, which are ascertained particularly using a GPS sensor. As a function of the individual instantaneous vehicle positions and the recorded kinematic state variables of the individual vehicles, the vehicles themselves are able to ascertain and calculate their corresponding vehicle position, and, if necessary, also calculate the vehicle positions of the other vehicles. If a vehicle has itself already determined its own vehicle position using a GPS sensor, the data which were sent to the vehicle are able to be used to form an improvement in the accuracy of the vehicle position measured using the GPS sensor.

Communication of the individual vehicles among one another is characterized in this instance by a bent double arrow having reference numeral 619. Communication of the individual vehicles among one another may be carried out particularly using a WLAN communications method and/or an LTE communications method and/or an Universal Mobile Telecommunications System (UMTS) mobile radio method. In particular, it may be provided that the communication between the individual vehicles be encrypted.

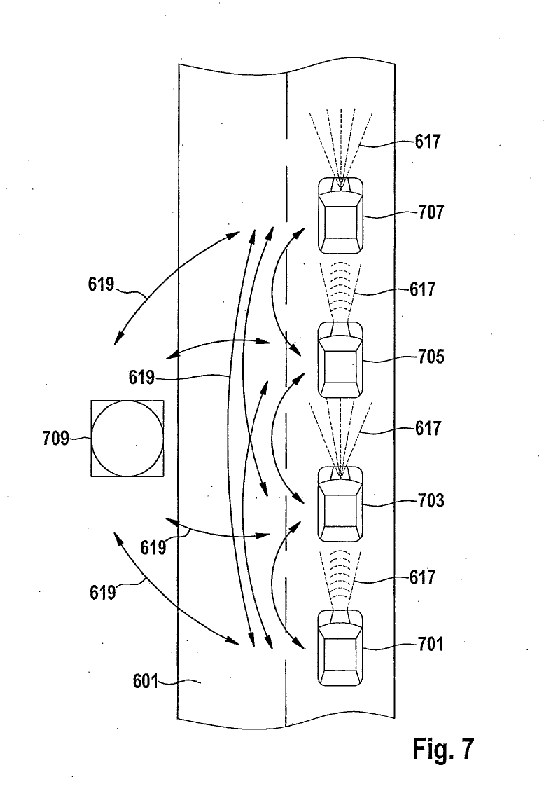

FIG. 7 shows a road 601, on which four vehicles 701, 703, 705 and 707 are moving one after the other in a common travel direction. A stationary physical object 709 is situated on the left next to road 601. The position of object 709 is also known to vehicles 701, 703, 705 and 707. The individual vehicles record a respective distance from one another and a relative speed and/or absolute speed, a relative acceleration and/or an absolute acceleration and/or an angle of the vehicles with respect to one another, using their respective sensor systems. Moreover, the vehicles may also each record a distance between themselves and object 709. It may also be particularly provided that the position of object 709 from at least one of vehicles 701, 703, 705 and 707 be recorded and notified to the other vehicles.

In the example shown in FIG. 7, the two vehicles 707 and 705 do not have sufficient reception in order to determine a position determination of their own vehicle position using their GPS sensor. The case may also occur in which the two vehicles 707 and 705 have, however, already determined their own vehicle position internally. However, this is not sufficiently accurate to arrive at a statement as to exactly in which lane or which lanes vehicles 707 and 705 are located. Vehicles 701 and 703, however, have sufficient reception for a position determination for their own vehicle position, using a GPS sensor. Since, however, a respective distance of the individual vehicles with respect to one another has been recorded and is therefore known, vehicles 701 and 703, based on their own vehicle position and on the distances and the additional kinematic state variables, are able to calculate the vehicle positions of vehicles 705 and 707 and send them to them. Provided vehicles 705 and 707 have already determined for themselves a vehicle position, that may perhaps not be sufficiently accurate, the vehicle position that was sent may be used for improving the accuracy of the corresponding internally determined vehicle position, so that, for instance, in an advantageous manner, a statement may be made as to exactly in which lane or in which lanes vehicles 705 and 707 are located. The explanations given in connection with the two vehicles 705 and 707 apply analogously to the two vehicles 701 and 703, so that these vehicles too are able to improve the accuracy of their self-determined vehicle position advantageously.

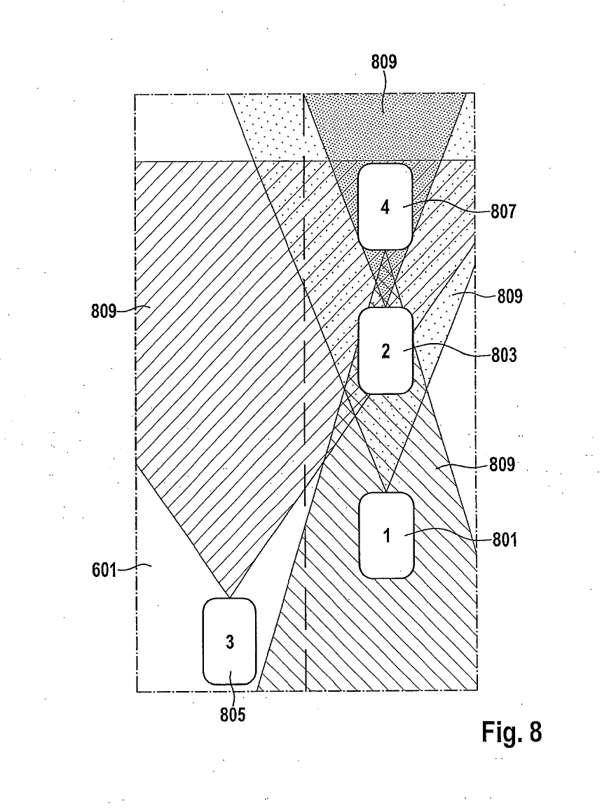

FIG. 8 shows a road 601, on which four vehicles 801, 803, 805 and 807 are located, which are traveling in a common travel direction. A recording angle of the corresponding sensor systems of the individual vehicles 801, 803, 805 and 807 is characterized in this case by reference numeral 809.

In this case it may particularly be provided that, to the state variables recorded by the individual vehicles, and their own vehicle position, in each case a quality factor be assigned which particularly may be a measure for the accuracy with which the individual variables and data were ascertained. Vehicle 801 may, for example, have a worse quality factor assigned to it with regard to its distance measuring system using which the state variables were recorded, since the distance measuring system may, for instance, be a simple smart phone camera. Vehicle 803 may have, for instance, an average quality factor, since the corresponding recording system, by which the state variables were recorded, has a standard camera, for example, having a sufficiently large sensor area.

Vehicle 805 may have, for instance, a good quality factor, since the corresponding recording system, by which the state variables were recorded, has a stereo camera. Vehicle 807 may have, for instance, a poor quality factor, since the corresponding recording system, by which the state variables were recorded, has a rearview camera.

If a vehicle is equipped with a differential GPS sensor, for example, a high quality factor may be assigned to it. In the case of a simple GPS sensor, a medium quality factor is assigned to the corresponding data, for example.

Consequently, particularly the following results of a corresponding distance measurement and particularly of a speed measurement, an acceleration measurement or an angle measurement are available:

Vehicle 805 is able to record the state variables of vehicle 803 and 807, since these are situated in its corresponding recording angle 809.

Vehicle 807, based on its rearview camera, is able to record the state variables of vehicle 803 and, using additional sensors, also the state variables of preceding vehicles that are not shown.

Vehicle 801 is able to record the state variables of vehicle 803.

Communication of vehicles 801, 803, 805 and 807 among one another and a corresponding recording of the respective distances from one another is analogous to the exemplary embodiments shown in FIGS. 6 and 7.

In the following text, additional specific embodiments are described with reference to two vehicles F1 and F2.

In one first specific embodiment, vehicle F1 either has no GPS sensor or, at the moment, no reception for the GPS sensor, so that vehicle F1 is not able to determine its own position. In this instance, vehicle F1 may be located in a tunnel or in a city having poor GPS reception.

Via its sensor system, vehicle F2 detects the relative position of vehicle F1, that is, in particular, the distance between F1 and F2, and, particularly optionally, a speed or an angle of vehicle F1.

Vehicle F2's own position as well as its global orientation, i.e. the direction of its speed, that is, its travel direction are particularly determinable using a GPS sensor, and are consequently known.

With the aid of its own position and the variables recorded using the environmental sensor system, vehicle F2 is now able to determine the vehicle position of F1, and to send this to vehicle F1 and particularly also to additional vehicles.

Thereby, in an advantageous manner, a position is ascertained for vehicle F1, which is not able to determine a position for itself.

The abovementioned steps could also be broadened for a chain/series of a plurality of vehicles (a column in a tunnel) and/or for an integration of stationary objects which know their position. In this case, the plurality of vehicles then exchange among one another their respectively recorded relative distances and additional kinematic state variables, as well as their own vehicle position, if present.

In one further exemplary embodiment, the two vehicles F1 and F2 have a GPS sensor and sufficient reception for determining their own vehicle position. Using their respective environmental sensor system, they are able to determine a relative distance and possibly a speed, as well as an angle between F1 and F2. In this case, it may also be provided that either only one of the two vehicles F1 and F2 has an environmental sensor system or that both have it.

Based on the information on the GPS positions of F1 and F2, as well as their distance apart and, if necessary, speed and angle, even more exact and accurate positions of vehicles F1 and F2 are able to be ascertained. Here too, a broadening to a plurality of vehicles and objects may be provided, which is carried out analogously.

In another exemplary embodiment, more than only two vehicles or objects may be provided. In this case, all or only some of the vehicles are able to determine their own vehicle position using a GPS sensor and to ascertain distance data to the other vehicles. Based on these data, for all the vehicles their own vehicle positions are able to be determined.

In one further exemplary embodiment, both vehicle F1 and F2 have a GPS sensor, but in each case have a satellite contact that is too little for a sufficiently accurate position determination, or a reception that is too poor for determining a sufficiently accurate vehicle position. The distance between

F1 and F2 is ascertained using a sensor system. The inaccurate GPS position may then advantageously be calculated more accurately using the ascertained distance, particularly if, in addition, a speed of vehicles F1 and F2 and/or an angle is recorded. In the calculation, in particular, a running time correction of the satellites may be used. The broadening for a plurality of vehicles or objects works analogously in this case in particular.

According to yet another specific embodiment, vehicle F1 has a GPS sensor, and is thus able to determine its own vehicle position. Furthermore, a stationary object O is provided, which has a position known to vehicle F1, this position having been determined very exactly and accurately, in particular. Vehicle F1 particularly ascertains the distance to stationary object O, especially using its sensor system and, as a function of the distance and its position determined using the GPS sensor, is able to determine an even more accurate and exact position for itself.

In one additional specific embodiment it may be provided that the vehicles send their respectively recorded data and determined positions to an external server, which then carries out the calculation for the vehicles, and sends the exact positions back to the vehicles. A communication between the vehicles and the server may, for instance, be carried out using the C21 communications method. Here the abbreviation C21 stands for the English expression “car to infrastructure”. A C21 communications method thus designates a communications method of a vehicle to an infrastructure and to a physical object, which is not a vehicle, such as a signal system or a base station. It is thereby also sufficient that the vehicles have control units available which are not particularly strong in performance, since the calculation is being done externally, after all. However, a combination of internal and external calculations may also be carried out, in particular.

1-11. (canceled)

12. A device for determining a position of a vehicle, comprising:
a position determining device for determining the position; and
a transmitter for sending the position to the vehicle.

13. The device of claim 12, wherein the position determining device determines an instantaneous position of the position determining device, and wherein a sensor system is is provided for recording a kinematic state variable of the vehicle.

14. The device of claim 13, wherein the sensor system is an environmental sensor system of a vehicle assistance system.

15. The device of claim 12, wherein the position of the vehicle is determined and transmitted to the vehicle.

16. The device of claim 15, wherein the determining of the position of the vehicle includes the recording of a kinematic state variable of the vehicle using a sensor system of a physical object, whose instantaneous position becomes determined.

17. The device of claim 16, wherein the recorded state variable and the instantaneous position are sent to an external server, which determines the position of the vehicle as a function thereof.

18. The device of claim 17, wherein the external server sends the position of the vehicle to other vehicles.

19. The device of claim 16, wherein the physical object is an additional vehicle.

20. A vehicle, comprising:
a device for determining a position of a vehicle, including:
a position determining device for determining the position; and
a transmitter for sending the position to the vehicle.

21. A system for determining a position of a vehicle, comprising:
an external server; and
a device for determining the position of the vehicle, including a position determining device for determining the position, and a transmitter for sending the position to the vehicle;
wherein the transmitter is configured to send the position of the vehicle to the server.

22. A computer readable medium having a computer program, which is executable by a processor, comprising:
a program code arrangement having program code for determining a position of a vehicle by determining the position and sending the position to the vehicle to a server.
